(19) United States
(12) Patent Application Publication
(10) Pub. No.: US 2023/0285966 A1
(43) Pub. Date: Sep. 14, 2023

(54) NANOFABRICATION OF DETERMINISTIC DIAGNOSTIC DEVICES

(71) Applicant: Board of Regents, The University of Texas System, Austin, TX (US)

(72) Inventors: Sidlgata V. Sreenivasan, Austin, TX (US); Aryan Mehboudi, Austin, TX (US); Akhila Mallavarapu, Philadelphia, PA (US); Paras Ajay, Austin, TX (US); Raul Marcel Lema Galindo, Austin, TX (US); Mark Hrdy, Austin, TX (US)

(21) Appl. No.: 18/018,546

(22) PCT Filed: Jul. 29, 2021
(86) PCT No.: PCT/US21/43722

§ 371 Date: Jan. 27, 2023

Related U.S. Application Data
(60) Provisional application No. 63/058,284, filed on Jul. 29, 2020.

(51) Int. Cl. B01L 3/00; G01N 21/65; B01D 67/00; B01D 69/02; B01D 71/02

(52) U.S. Cl. CPC B01L 3/502753; G01N 21/658; B01D 67/0062; B01D 69/02; B01D 71/0213; B01D 2325/08; B01L 2300/0636; B01L 2300/0681; B01L 2200/0652; B01L 2400/0487

(57) ABSTRACT

A diagnostic chip for detecting biomarkers and trace amounts of nanoparticles in chemical mixtures or in water. The diagnostic chip includes one or more inputs, where a sample containing differently sized particles is introduced into at least one of these inputs. Furthermore, the diagnostic chip includes multiple separation regions, where the sample is pressurized as it passes through the separation regions. Each separation region includes a deterministic lateral displacement array, where the deterministic lateral displacement array in two or more of these separation regions has a different etch depth profile. In this manner, the diagnostic chip effectively detects biomarkers and trace amounts of nanoparticles in chemical mixtures or in water.

### TECHNICAL FIELD

The present invention relates generally to diagnostic devices, and more particularly to nanofabrication of deterministic diagnostic devices.

### BACKGROUND

Diagnostic devices, such as medical diagnostic devices, help clinicians to measure and observe various aspects of a patient's health so that they can form a diagnosis. Once a diagnosis is made, the clinician can then prescribe an appropriate treatment plan.

Medical diagnostic devices are found in outpatient care centers for adult and pediatrics, in emergency rooms as well as in inpatient hospital rooms and intensive care units.

Such diagnostic devices may be used to detect small concentrations of biomolecules in order to provide early detection of a disease as well as to monitor a patient response to treatments. Such diagnostic tools can assist the clinician to make crucial decisions regarding the treatment method and to improve the treatment outcome of the patient. At early stages of disease, the concentration of disease markers is very low and hard to detect in typical media, such as blood, urine, blood plasma, serum, etc. Capturing and separating biomarkers, such as tumor cells and exosomes, may enable sensors to detect them. In biomedical contexts, a biomarker or biological marker is a measurable indicator of some biological state or condition. Similarly, detecting trace amounts of nanoparticles in chemical mixtures or in water have important applications.

Unfortunately, there is not currently a means for diagnostic devices to effectively detect such biomarkers or to effectively detect trace amounts of nanoparticles in chemical mixtures or in water.

### SUMMARY

In one embodiment of the present invention, a diagnostic chip comprises one or more inputs, where a sample containing differently sized particles is introduced into at least one of the one or more inputs. The diagnostic chip further comprises a plurality of separation regions, where the sample is pressurized as it passes through the plurality of separation regions, where each of the plurality of separation regions comprises a deterministic lateral displacement array, and where the deterministic lateral displacement array in two or more of the plurality of separation regions has a different etch depth profile.

In another embodiment of the present invention, a device for separation of one or more biological species comprises a separation region comprising micro-scale or nano-scale structures, where an underlying substrate of the separation region is non-porous. The device further comprises at least one output region, where an underlying substrate of the at least one output region is porous.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates silicon nanopillars made with catalyst influenced chemical etching (CICE) for deterministic lateral displacement (DLD)-based particle separation in accordance with an embodiment of the present invention;

FIG. 2 illustrates the equipment (“tabletop” equipment) to provide liquids and gasses to a diagnostic chip (“disposable chip”) as well as to inspect the diagnostic chip in accordance with an embodiment of the present invention;

FIGS. 3A-3D illustrate an embodiment of the disposable diagnostic chip in accordance with an embodiment of the present invention;

FIGS. 4A-4B illustrate a second embodiment of the disposable diagnostic chip in accordance with an embodiment of the present invention;

FIG. 5A illustrates a top view of the pillar arrays in accordance with an embodiment of the present invention;

FIG. 5B illustrates the three arrangements of the pillar arrays in accordance with an embodiment of the present invention;

FIG. 6 illustrates an embodiment of the diagnostic chip where the micro/nanofabricated silicon is integrated with the top transparent substrate with the micro/nano pillar arrays acting as a spacer that creates a micro-scale gap between the bottom of the pillars and the top substrate in accordance with an embodiment of the present invention;

FIG. 7 is a flowchart of a method for fabricating silicon nanopillars in accordance with an embodiment of the present invention;

FIGS. 8A-8D depict cross-sectional views for fabricating silicon nanopillars using the steps described in FIG. 7 in accordance with an embodiment of the present invention;

FIGS. 9A-9D illustrate the images of a 4-inch wafer after each process step illustrated in FIGS. 8A-8D, respectively, in accordance with an embodiment of the present invention;

FIG. 10 illustrates the top-down SEM (scanning electron microscope) image of the silicon nanowires made with metal assisted chemical etching (MACE) in accordance with an embodiment of the present invention;

FIG. 11 illustrates the cross-section SEM image of the silicon nanowires made with MACE in accordance with an embodiment of the present invention;

FIG. 12 illustrates an exemplary side-barrier array for particle separation in accordance with an embodiment of the present invention;

FIG. 13 is a flowchart of a method for creating self-aligned pillars using the MACE process in accordance with an embodiment of the present invention; and

FIGS. 14A-14C depict cross-sectional views for creating self-aligned pillars using the MACE process using the steps described in FIG. 13 in accordance with an embodiment of the present invention.

### DETAILED DESCRIPTION

As stated in the Background section, there is not currently a means for diagnostic devices to effectively detect biomarkers or to effectively detect trace amounts of nanoparticles in chemical mixtures or in water.

The principles of the present invention provide a means for effectively detecting biomarkers and effectively detecting trace amounts of nanoparticles in chemical mixtures or in water.

In one embodiment, the principles of the present invention perform such detection using a technique referred to herein as the “deterministic lateral displacement (DLD).” DLD is a microfluidic technique which separates particles in a fluid medium based on their size, using specific arrangements of pillars arrays placed within a microfluidic channel. The gaps between the pillars and the placement of the pillars determine the separation mechanics. A further description of DLD may be found in Huang et al., “Continuous Particle Separation Through Deterministic Lateral Displacement,” Science, Vol. 304, No. 5673, May 2004, pp. 987-990; McGrath et al., “Deterministic Lateral Displacement for Particle Separation: A Review,” Lab on a Chip, Vol. 14, No. 21, 2014, pp. 4139-4158; Inglis et al., “Critical Particle Size for Fractionation by Deterministic Lateral Displacement,” Lab on a Chip, Vol. 6, No. 5, May 2006, pp. 655-658; and Wunsch et al., “Nanoscale Lateral Displacement Arrays for the Separation of Exosomes and Colloids Down to 20 nm,” Nature Nanotechnology, Vol. 11, No. 11, November 2016, pp. 936-940, each of which are incorporated by reference herein in their entirety.

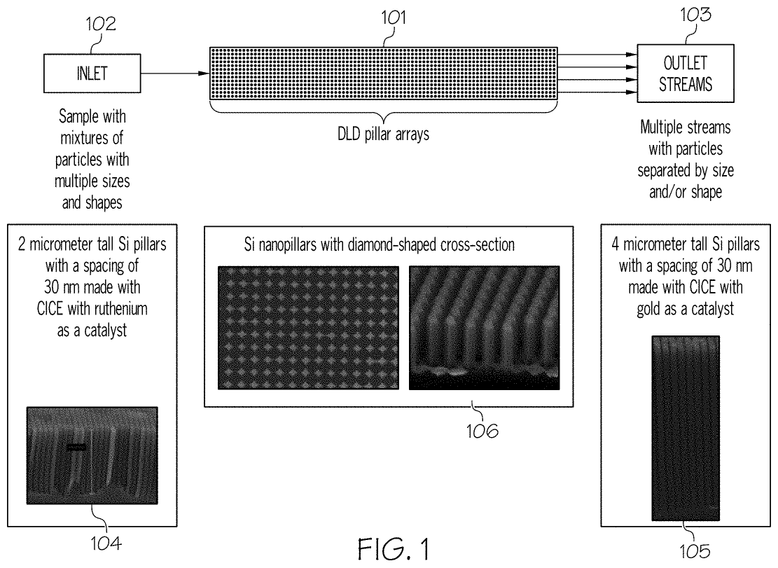

Referring now to the Figures in detail, FIG. 1 illustrates silicon nanopillars made with catalyst influenced chemical etching (CICE) for DLD-based particle separation in accordance with an embodiment of the present invention.

As shown in FIG. 1, the pillar arrays 101 required for DLD receive a sample via inlet 102 that includes mixtures of particles with multiple sizes and shapes and produces via output streams 103 multiple streams with particles separated by size and/or shape. In one embodiment, DLD pillar arrays 101 generate a pattern to maximize separation efficiency and throughput using the following variables: pillar size and spacing, pillar shapes (e.g., circle, triangle, diamond, streamlined, etc.), pillar array placement and skew angle, and pillar height before collapse. Furthermore, as shown in FIG. 1, an illustration 104 of a sample in inlet 102 corresponds to pillars that are 2 micrometers tall with a spacing of 30 nm made with CICE with ruthenium as a catalyst. Additionally, as shown in FIG. 1, an illustration 105 of outlet streams 103 includes silicon (Si) pillars that are 4 micrometers tall with a spacing of 30 nm made with CICE with gold as a catalyst. Furthermore, as shown in FIG. 1, an illustration 106 of DLD pillar arrays 101 includes silicon (Si) nanopillars with a diamond-shaped cross-section.

In one embodiment, DLD pillar arrays 101 are fabricated using nanolithography, such as nanoimprint lithography combined with a metal assisted chemical etching (MACE) process. Further details regarding DLDs and fabrication using MACE are found in Cherala et al., “Nanoshape Imprint Lithography for Fabrication of Nanowire Ultracapacitors,” IEEE Transactions on Nanotechnology, Vol. 15, No. 1, January 2016, pp. 448-456; Mallavarapu et al., “Enabling Ultra-High Aspect Ratio Silicon Nanowires Using Precise Experiments for Detecting Onset of Collapse,” Nano Letters, Vol. 20, No. 11, 2020, pp. 7896-7905; and Mallavarapu et al., “Scalable Fabrication and Metrology of Silicon Nanowire Arrays made by Metal Assisted Chemical Etching,” IEEE Transactions on Nanotechnology, Vol. 20, 2021, pp. 83-91, each of which are incorporated by reference herein in their entirety.

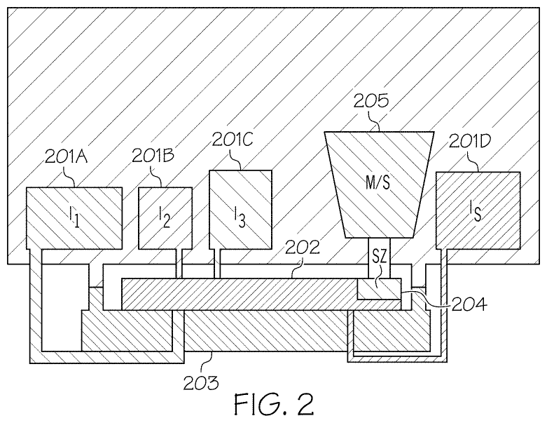

Referring now to FIG. 2, FIG. 2 illustrates the equipment (“tabletop” equipment) to provide liquids and gasses to a diagnostic chip (“disposable chip”) as well as to inspect the diagnostic chip in accordance with an embodiment of the present invention.

As shown in FIG. 2, tabletop equipment 201A-201D provides a variety of inputs (marked I₁, I₂, I₃, I_{S}, respectively) which are connected to the disposable diagnostic chip 202. Equipment 201A-201D may collectively or individually be referred to as equipment 201. While FIG. 2 illustrates four pieces of equipment 201, it is noted that the principles of the present invention may utilize any number of tabletop equipment 201.

Referring again to FIG. 2, if chip 202 is located with sufficient accuracy on a chip holder 203 which is connected by a frame to the equipment body, chip 202 registers with the various inlets and can receive buffer liquids (such as purified water), pressure source, solvents needed during the operation of chip 202, etc. Chip 202 also receives a “sample” which can be a patient's blood, urine, saliva, serum, etc. In one embodiment, the system is designed to avoid any backflow of the “sample” into any of the reservoirs holding clean liquids in the equipment. A further description of disposable diagnostic chip 202 is provided further below.

Also, as shown in FIG. 2, the “SZ” corresponds to the sensor zone 204 which is optically inspected using an instrument 205 marked “M/S” which may be a microscope, a fluorescence microscope, a spectrometer, a Raman spectrometer, etc.

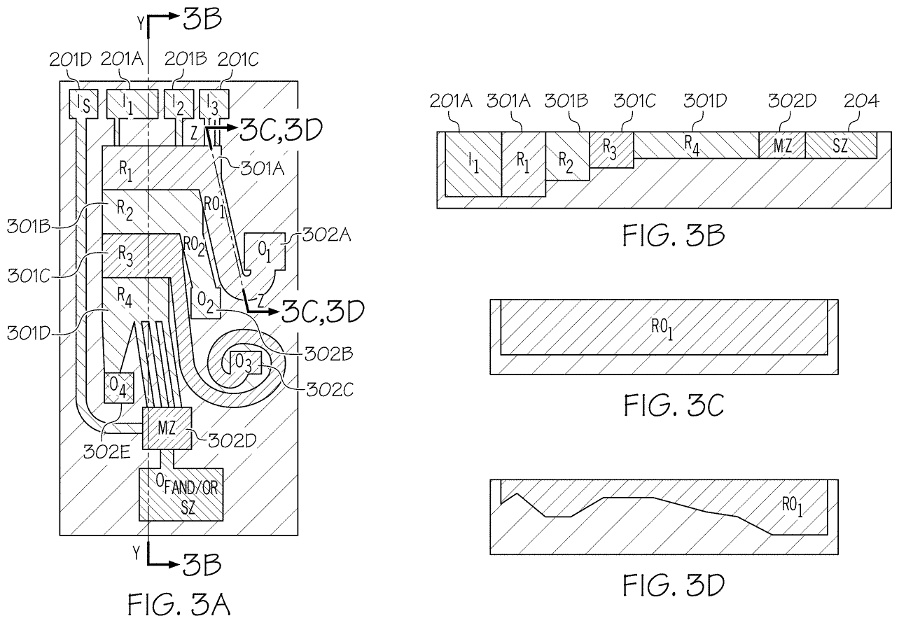

Referring now to FIGS. 3A-3D, FIGS. 3A-3D illustrate an embodiment of disposable diagnostic chip 202 in accordance with an embodiment of the present invention.

FIG. 3A illustrates a top view of the diagnostic chip and FIG. 3B illustrates a cross-section along the vertical direction Y-Y shown in FIG. 3A. A variety of inputs (marked I₁, I₂, I₃, I_{S}) are shown and represent the same inputs as shown in FIG. 2. While only 4 inputs are shown, these devices may include any number of inputs, including 25 or more inputs. In one embodiment, the “sample” containing differently sized particles is introduced in one of the inputs I₁, I₂, or I₃. The sample along with other liquids, such as buffer liquids, are pressurized, and they pass through Regions 1 through 4 (301A-301D, respectively) (identified as “R1,” “R2,” “R3,” and “R4,” respectively). Regions 301A-301D may collectively or individually be referred to as regions (or “separation regions”) 301 or region (or “separation region”) 301, respectively. Once again, it is noted that while only 4 regions are shown, there may be any number of regions, including having 25 or more regions. In one embodiment, these regions are designed to carry out hierarchical filtration of particles leading to each output reservoir (O₁ through O₃ and the output MZ) (identified as output 302A-output 302D, respectively) having monotonically decreasing particle sizes captured in them. Output O₄ 302E collects left over liquids and other debris that are very small (e.g., <10 nm or <25 nm) in size. Outputs 302A-302E may collectively or individually be referred to as outputs 302 or output 302, respectively. The sample flowing through Region R₁ to output O₁ is identified as RO₁. Similarly, the sample flowing through Region R₂ to output O₂ is identified as RO₂. The size range of particles that end up in O₁ through O₃, the output MZ, and O₄ depends on the design of the DLD regions Rᵢ. The size of the pillars, the spacing, their height, their arrangement, their orientation with respect to the flow direction, and their cross-section shapes all decide the range of particles filtered as discussed in Huang et al., “Continuous Particle Separation Through Deterministic Lateral Displacement,” Science, Vol. 304, No. 5673, May 2004, pp. 987-990; McGrath et al., “Deterministic Lateral Displacement for Particle Separation: A Review,” Lab on a Chip, Vol. 14, No. 21, 2014, pp. 4139-4158; Inglis et al., “Critical Particle Size for Fractionation by Deterministic Lateral Displacement,” Lab on a Chip, Vol. 6, No. 5, May 2006, pp. 655-658; and Wunsch et al., “Nanoscale Lateral Displacement Arrays for the Separation of Exosomes and Colloids Down to 20 nm,” Nature Nanotechnology, Vol. 11, No. 11, November 2016, pp. 936-940.

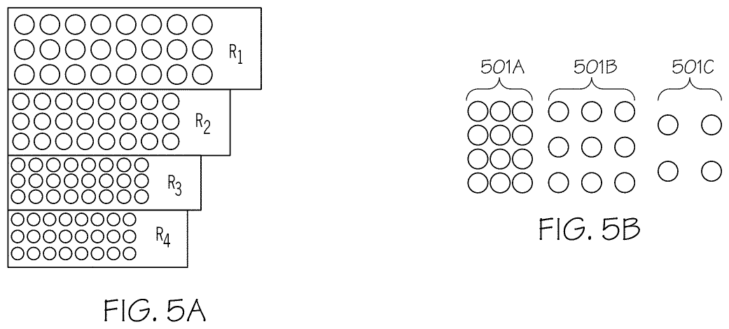

In one embodiment, Region 1 is assumed to have large DLD pillar arrays with relatively large diameters (e.g., 25-50 micrometers). Region 2 is assumed to have somewhat smaller DLD pillar arrays (e.g., in the range of 5-25 micrometers). Region 3 is assumed to have further smaller DLD pillar arrays (e.g., in the range of 0.5-5 micrometers). Furthermore, in this design, Region 4 is assumed to have the smallest DLD pillar arrays (e.g., in the range of 25 nm-500 nm). In one embodiment, the spacing between these pillars can be high making them “sparse” (shown in FIG. 5B discussed further below). In one embodiment, “sparse” pillars have the ratio of diameter to pitch of 1% to 35% (d/p=0.01 to 0.35). In one embodiment, “medium” pillars have the ratio of diameter to pitch of 35% to 65% (d/p=0.35 to 0.65). In one embodiment, “dense” pillars have the ratio of diameter to pitch of 55% to 99% (d/p=0.65 to 0.99). In one embodiment, a combination of nanoimprint and MACE are used to achieve these dense pillar fabrication, particularly when the spacing between the pillars goes well below 25 nm. A discussion of such fabrication is provided in Mallavarapu et al., “Enabling Ultra-High Aspect Ratio Silicon Nanowires Using Precise Experiments for Detecting Onset of Collapse,” Nano Letters, Vol. 20, No. 11, 2020, pp. 7896-7905; and Mallavarapu et al., “Scalable Fabrication and Metrology of Silicon Nanowire Arrays made by Metal Assisted Chemical Etching,” IEEE Transactions on Nanotechnology, Vol. 20, 2021, pp. 83-91.

In one embodiment, input I_{S} is an optional input for a solvent or a chemical that mixes with one of the outputs (in FIGS. 3A-3B, this is the output MZ, which corresponds to the mixing zone). In one embodiment, the output arriving at MZ may be exosomes or antibodies that are in the size range of 25 nm-150 nm. If particles, such as exosomes, are exposed to an appropriate chemical or solvent that arrives from I_{S} to MZ, this chemical can break the exosome wall and release the contents of the exomes, which are biomolecules (biomarkers) that represent the cell from where the exosome originated. Finally, in one embodiment, there is an optional sensor zone 204 (marked SZ in FIGS. 2 and 3A-3B) Hence, the mixing zone (MZ) may include one of the outputs 302 (e.g., identified as OF) and/or SZ 204. In one embodiment, sensor zone 204 captures the biomarkers released from the exosomes and detects them using instrumentation, such as a microscope, a fluorescence microscope, a spectrometer, a Raman spectrometer, etc. In particular, if SZ 204 is designed to enhance the Raman signal, it may contain surface enhanced Raman spectroscopy (SERS) patterns fabricated in plasmonic materials, such as Au, Ag, or Cu, or more complicated material stacks, such as discussed in Sharma et al., “SERS: Materials, Applications and the Future,” Materials Today, Vol. 15, Nos. 1-2, January-February 2012, pp. 16-25, which is incorporated by reference herein in its entirety.

It is noted that there is evidence that exosomes are used for transferring of growth factors, micro RNA (miRNA), mRNA, and enzymes, among others, which play an important role in regulation of cellular activity. In the context of immunoregulation, exosome secretion acts as a unidirectional delivery vehicle for miRNA capable of regulating gene expression of the target cell. Exosome-based cell-free therapies have been identified as a potential approach for regenerative medicine without the need of stem cell implantation. Once the cell exosomes have been separated using the device described herein, these vesicles can be analyzed in two ways. First, a proteomic analysis can be performed to look for surface markers, such as Tetraspanins (CD9, CD63, CD81), adhesion proteins, or cell-specific surface markers (T cell receptor, CAR-T receptor, major histocompatibility complex (MHC) proteins, etc.) among others. These surface markers allow for the initial identification of exosomes in solution and can provide information as to the origin of the vesicles and potential for cell-cell communication and recognition between source and target in the physiological environment. Therapeutic potential of the exosomes can be further assessed by analyzing the contents of the exosomes. In one embodiment, the therapeutic potential of the exosomes are assessed by lysing the isolated exosomes using an organic solvent, such as methanol, and then depositing the contents on a SERS substrate for protein identification and analysis, or isolated for further genetic characterization.

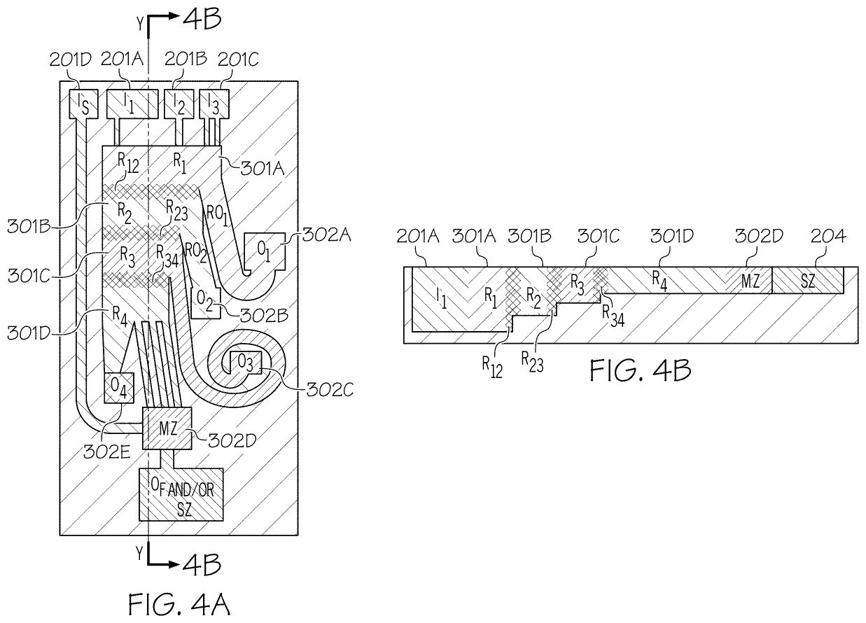

In one embodiment, the various regions may need to be etched to different heights so as to keep aspect ratios of these pillars reasonable. For example, if the pillars being made in Region 4 (R₄) have a diameter of 100 nm, while the pillars being made in Region 1 (R₁) have 25 micrometer diameter pillars, then the etch depth in Region 1 may be 25 micrometers while the etch depth in Region 4 may need to only be 1 micrometer. FIG. 3B illustrates this variable etch depth for each region causing the transition between one region to the next involving a step. Such step height changes though may cause problems with fluid flow. For example, at the step between R₁ and R₂, the step may cause some of the smaller particles that need to continue on to Regions 2, 3 or 4, to get stuck at the foot of the step between R₁ and R₂. This problem can be addressed by an alternative embodiment shown in FIGS. 4A-4B, which illustrate a second embodiment of the disposable diagnostic chip in accordance with an embodiment of the present invention.

FIG. 4A illustrates a top view of the diagnostic chip and FIG. 4B illustrates a cross-section along the vertical direction Y-Y shown in FIG. 4A. As shown in FIGS. 4A-4B, the transitions (between R₁ and R₂, which is indicated as Rig; between R₂ and R₃, which is indicated as R₂₃; between R₃ and R₄, which is indicated as R₃₄) are made to be gradual, with ramps between any two regions. The fabrication of these ramps can be challenging and approaches to address these fabrication challenges are discussed later herein.

An important challenge in the multi-region cascading DLD devices that incorporate both micro-scale and nano-scale DLD regions is the need to approximately match the flow resistivity as flow bifurcates and moves towards the various outputs. It is, for example, desirable to have the various flow resistivity (measured in Newton-second-meter⁻⁵ or N.s./m⁵) to be within about 10× of each other. The flow resistivity of a channel is defined by the lateral (width) parameters, the channel depth, and the channel length. Where the resistivity is too low, the resistivity can be increased to come closer to matching other path resistivities. This increase can be achieved by using one or more of the following approaches: (i) increase the length significantly—this can be done efficiently by using spiral flow channels (e.g., see channel for output O₃ in FIG. 3A or serpentine flow channels without any sharp bends that can cause flow disruptions; (ii) adding regions of “dense” pillars where d/p>0.9 or >0.95; and (iii) decreasing the etch height of the channels in local areas. This last concept is illustrated in FIGS. 3C and 3D that are both cross-section Z-Z in FIG. 3A. In FIG. 3C, the etch depth is constant which is relatively easy to fabricate. In FIG. 3D, however, the etch depth is shown to vary in a complicated manner. If such etch depth variations can be created, the cascading fluidic system can be designed to have reasonably matched flow resistance. The etch depth variation in fabrication is discussed further below.

Referring to FIG. 5A, FIG. 5A illustrates a top view of the pillar arrays 101 (FIG. 1) in accordance with an embodiment of the present invention. As shown in FIG. 5A, the pillar diameters decrease from Region R₁ through Region R₄, such as shown in FIGS. 3B and 4B. Furthermore, FIG. 5B illustrates the three arrangements of the pillar arrays in accordance with an embodiment of the present invention. As shown in FIG. 5B, the three types of arrangements of the pillar arrays are dense 501A, medium 501B and sparse 501C patterns.

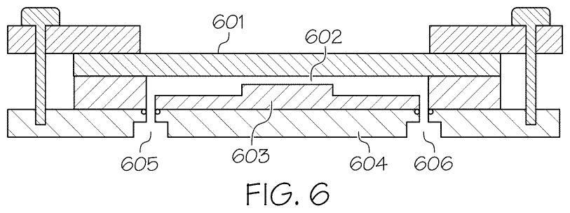

FIG. 6 illustrates an embodiment of the diagnostic chip where the micro/nanofabricated silicon is integrated with the top transparent substrate 601 (e.g., glass, polydimethylsiloxane (PDMS)) with the micro/nano pillar arrays (not shown in this Figure) acting as a spacer that creates a micro-scale gap 602 between the bottom of the pillars 603 (e.g., silicon pillars) and the top substrate 601 in accordance with an embodiment of the present invention. Also, a plexiglass substrate 604 is shown with an optional inlet hole 605 and outlet hole 606 machined. In one embodiment, the plexiglass-silicon-top substrate (604-603-601) sandwich is held together with screws as shown in FIG. 6.

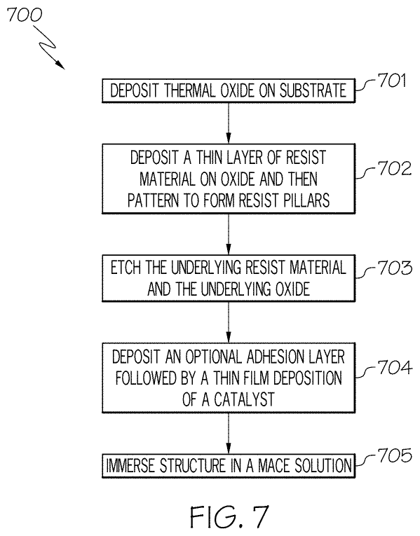

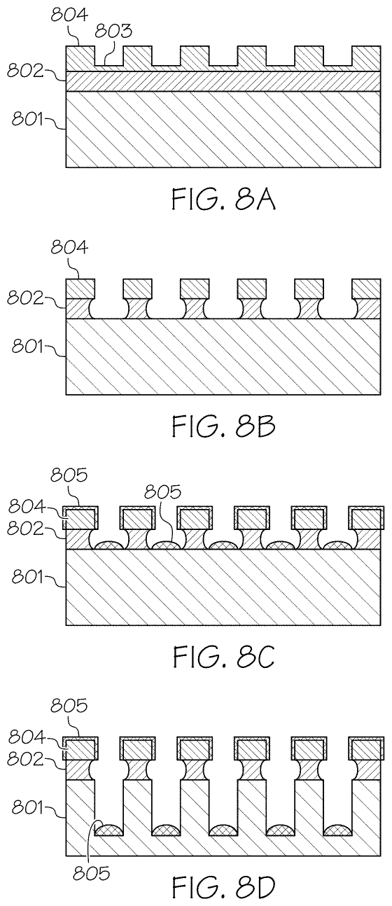

Referring now to FIG. 7, FIG. 7 is a flowchart of a method 700 for fabricating silicon nanopillars in accordance with an embodiment of the present invention. FIGS. 8A-8D depict cross-sectional views for fabricating silicon nanopillars using the steps described in FIG. 7 in accordance with an embodiment of the present invention.

Referring to FIG. 7, in conjunction with FIGS. 8A-8D, in step 701, thermal oxide 802 is deposited on a substrate 801, such as a silicon wafer (e.g., p-type (100) silicon wafer with a resistivity of 1-10 ohm-cm), as shown in FIG. 8A. In one embodiment, a 30-100 nm thick thermal oxide 802 is grown on substrate 801.

In step 702, a thin layer of resist material 803 (e.g., polymer) is deposited on oxide 802 and then patterned to form resist pillars 804 (circular), such as the pillars of deterministic lateral displacement pillar arrays, as shown in FIG. 8A. In one embodiment, the thickness of the resist material is between 10-30 nm. In one embodiment, the resist material is patterned using imprint lithography.

In step 703, the underlying resist material 803 and the underlying oxide 802 are etched as shown in FIG. 8B. In one embodiment, the underlying residual resist layer 803 of 10-30 nm is removed (descumed) by an oxygen plasma etch. In one embodiment, the underlying oxide 802 is etched either using a short buffered oxide etch (BOE) (e.g., 6:1) to isotropically etch oxide layer 802 or using a reactive ion etch of oxide 802 followed by a short BOE dip.

In step 704, an optional adhesion layer (not shown in FIGS. 8A-8D) is deposited followed by a thin film deposition of a catalyst 805 as shown in FIG. 8C. In one embodiment, an adhesion layer, such as titanium (Ti), is deposited on resist pillars 804 and the remaining oxide 802 followed by a thin film deposition of a catalyst 805, such as silver, gold, palladium, platinum and ruthenium. In one embodiment, the adhesion layer has a thickness of 2 nm. In one embodiment, the type of catalyst is a MACE catalyst. In one embodiment, the thickness of catalyst layer 805 is between 2 nm and 50 nm. In one embodiment, the material of catalyst 805 is gold with a thickness of 10 nm or 4 nm.

In step 705, the structure of FIG. 8C is immersed in a MACE solution as shown in FIG. 8D. In one embodiment, the patterned wafer is immersed in a MAC solution of 12.5 moles HF and 1 mole of H₂O₂. In one embodiment, the etch can be quenched in a wafer and subsequently rinsed with water and dried with an air gun supplying clean dry air (CDA). In one embodiment, catalyst 805 (e.g., gold catalyst) can be optionally removed using a Transene™ potassium iodide-based gold etchant. The remaining resist can be optionally removed using a short oxygen plasma.

In one embodiment, using method 700, pillars 804 are designed to prevent clogging of particles in the sample fluids.

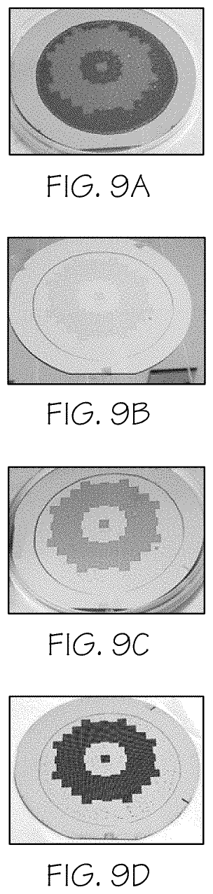

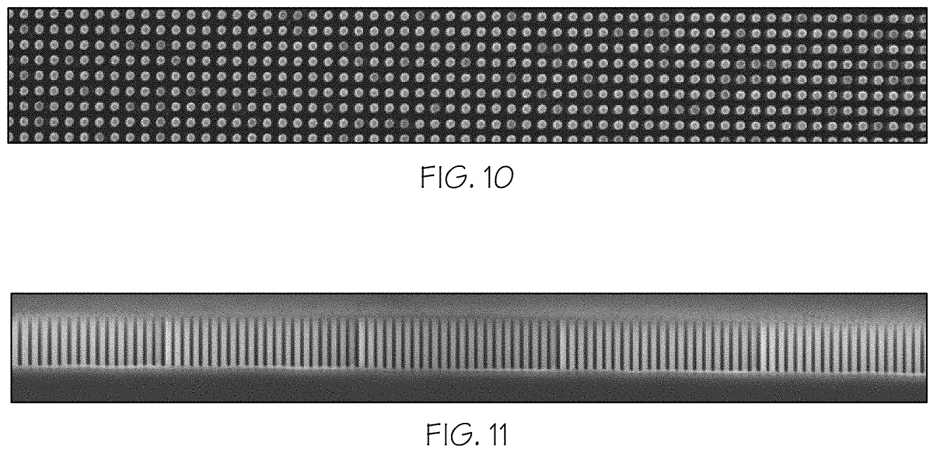

FIGS. 9A-9D illustrate the images of a 4-inch wafer after each process step illustrated in FIGS. 8A-8D, respectively, in accordance with an embodiment of the present invention.

FIG. 10 illustrates the top-down SEM (scanning electron microscope) image of the silicon nanowires made with MACE as discussed above in connection with FIGS. 7 and 8A-8D in accordance with an embodiment of the present invention. In FIG. 10, the scale bars are 1 micrometer.

FIG. 11 illustrates the cross-section SEM image of the silicon nanowires made with MACE as discussed above in connection with FIGS. 7 and 8A-8D in accordance with an embodiment of the present invention. In FIG. 11, the scale bars are 1 micrometer.

Referring to FIGS. 7, 8A-8D, 9A-9D, 10 and 11, the above process has nanometer scale resolution and can be used to create pillars that are 50 nm in diameter or smaller and with <5 nm spacing. The process can also simultaneously create small (sub-100 nm) and large (>25 micrometers) pillars over the device area, and large etched areas (e.g., square or circular areas that have a size or diameter of at least 25 micrometers to as high as millimeters). In one embodiment, such large etched areas are created using the gold catalyst deposited as a thin film (<15 nm) with or without Ti, with an optional annealing step, so that the gold film has very fine porosity thereby letting the etchant go through the finely porous gold to etch the large areas. A discussion regarding the porous gold is provided in Nichkalo et al., “Silicon Nanostructures Produced by Modified MacEtch Method for Antireflective Si Surface,” Nanoscale Research Letters, Vol. 12, No. 106, 2017, pp. 1-6, which is incorporated by reference herein in its entirety.

In one embodiment, the porous gold film results in the creation of silicon “nanowhiskers” in areas corresponding to pore locations on the gold film. These silicon nanowhiskers are optionally removed using techniques, such as silicon etch with potassium hydroxide (KOH), or oxidation of the nanowhiskers and etch using hydrofluoric acid (HF), where oxidation is performed using oxygen plasma, using oxidants, such as nitric acid, electrochemical anodization, etc.

In one embodiment, for nanoimprinting of these features, a template replica is made using an electron beam master that has holes in the master and creates pillars in fused silica after the imprint and reactive ion etch. Then, the fused silica master is coated with atomic layer deposition of oxide to create pillars of increased size for a given pitch as discussed in Cherala et al., “Nanoshape Imprint Lithography for Fabrication of Nanowire Ultracapacitors,” IEEE Transactions on Nanotechnology, Vol. 15, No. 1, January 2016, pp. 448-456. The resulting fused silica replica can be used in the above nanoimprint followed by the MACE process shown in FIGS. 7 and 8A-8D.

In one embodiment, the controlled etch depth variation shown in FIGS. 3C and 4B are achieved by using one or more of the following approaches.

In one approach, local temperature is used to control the etch rate of silicon during the MACE process as discussed in international application number PCT/US2018/060176, which is incorporated by reference herein in its entirety. This allows for increased etch rates in areas where the silicon wafer has a higher temperature and will have a graded etch rate in the transition areas going from the hotter region to the cooler region.

In another approach, the etch rates in local regions are controlled by controlling the amount of etchant supplied to each part of the wafer. This idea of creating etch depth variations using the control of etchant transport is included in FIG. 3 of Mallavarapu et al., “Enabling Ultra-High Aspect Ratio Silicon Nanowires Using Precise Experiments for Detecting Onset of Collapse,” Nano Letters, Vol. 20, No. 11, 2020, pp. 7896-7905. One way to create this etchant flow control is to (i) first use the MACE process of FIGS. 7 and 8A-8D to create a short uniform etch of silicon nanowires (e.g., 100 nm etch depth); followed by (ii) removing the wafer from the etchant, quenching it with water and drying it; followed by (iii) a deposition of an inkjet based UV curable monomer material (such as an acrylate discussed in Choi et al., “UV Nanoimprint Lithography,” Handbook of Nanofabrication, edited by Gary Wiederrecht, Elsevier Press, October 2009, 310 pages, see pp. 149-181, which is incorporated by reference herein in its entirety) to selectively block portions of the silicon wafer, followed by (iv) re-inserting the wafer in the MACE etchant thereby continuing the MACE process in areas which are unblocked. The UV curable material can be inkjetted to either:
(1) Fully blocked regions where further etch is to be discontinued (e.g., regions R₄, MZ, and SZ once they have reached their full etch depth), or
(2) Partially blocked regions (here the inkjetted drops of monomer are dispensed and UV cured before they fully merge therefore leaving small gaps at the interstitial regions of the drops and these gaps define the amount of etchants that would penetrate through to the underlying silicon for MACE etch), or
(3) Regions that are unblocked where there is no monomer inkjetted so that the MACE etch continues unhindered.

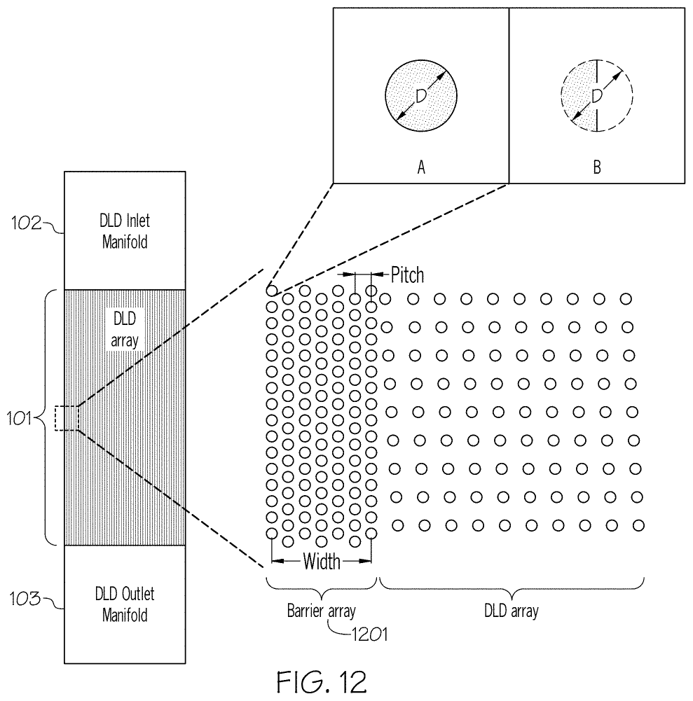

In another embodiment, the DLD pillar array 101 (see FIG. 1) could have a dense array (staggered or otherwise) of pillars that act as barriers to fluid flow and leakage laterally (see FIG. 12 discussed below). These barrier arrays are essentially dense pillars as discussed in FIG. 5B, and may be “hyper-dense.” “Hyper-dense,” as used herein, refers to the d/p>0.9 or >0.95. The cross-sections of individual pillars of the barrier array do not have to be circularly symmetric shapes. For example, they can be asymmetric shapes as well. The asymmetric shapes would restrict the leakage of the fluid from the DLD pillar array 101 to outside, but would permit injection of fluids from the outside into DLD pillar array 101, which could be used to perform in-situ operations on the contents of the DLD as shown in FIG. 12. FIG. 12 illustrates an exemplary side-barrier array for particle separation in accordance with an embodiment of the present invention.

Referring to FIG. 12, FIG. 12 illustrates DLD pillar array 101 along with the inlet manifold 102 and the outlet manifold 103. In one embodiment, the barrier layer/array 1201 can be fabricated along with the DLD pillar array 101 as discussed above and does not need any separate fabrication steps. The width of the side-barrier array can range from less than a micrometer to above a millimeter. These barrier arrays have the advantage that in the timescales of these devices, the barriers do not allow passage of any relevant particles, and only let through a very small percentage of liquid to seep through.

In one embodiment, the principles of the present invention create a porous layer for liquid draining prior to the surface enhanced Raman spectroscopy (SERS) detection.

In one embodiment, the buffer solution containing biological or chemical particles to be detected using the diagnostic device discussed herein, if being detected by SERS, can be drained using a porous silicon layer underneath the gold patterns for enhanced SERS detection. In one embodiment, the porous silicon layer is designed to act as a drain for sample liquids while preventing particles in the fluid from seeping into pores in the porous silicon layer. In one embodiment, the porous silicon layer is formed after a SERS “bathtub” is created using MACE in the SZ area of FIGS. 2, 3A-3B and 4A-4B. In one embodiment, the SERS “bathtub” is connected to a desired DLD array outlet, has an area of 2 mm×2 mm, and a depth of 1 micrometer. The “bathtub” is etched along with the rest of the DLD arrays, inlets, and outlets. The gold catalyst is etched away (such as discussed in T. A. Green, “Gold Etching for Microfabrication,” Gold Bulletin, Vol. 47, No. 3, 2014, pp. 205-216, which is incorporated by reference herein in its entirety) using a wet etch (such as potassium iodide based or aqua regia), a plasma etch, or an atomic layer etch. In one embodiment, an inkjet is used to dispense polymer blocking material in all areas except the SERS “bathtub” regions. In one embodiment, a porous layer is created by electrochemical etching of the silicon in the SERS “bathtub” area using electric fields and an electrolyte comprising of HF. In one embodiment, the morphology of the porous layer (porosity, pore size, and pore orientation) is controlled by changing the voltage and/or current density across the wafer, such as discussed in Volker Lehmann, “Electrochemistry of Silicon: Instrumentation, Science, Materials and Applications,” Wiley-VCH Verlag GmbH, Weinheim, 2002, pp. 1-115; and Alexey Ivanov, “Silicon Anodization as a Structuring Technique: Literature Review, Modeling and Experiments,” 2018, pp. 1-316, which are each incorporated by reference herein in their entirety.

In another embodiment, the gold catalyst (e.g., catalyst 805) is used to create the porous layer underneath the bathtub using an optimized MACE etchant composition, in conjunction with electric fields after blocking out all the other regions except for the SZ region using a polymer coating, such as an inkjetted and UV cured acrylate material, as discussed in Choi et al., “UV Nanoimprint Lithography,” Handbook of Nanofabrication, edited by Gary Wiederrecht, Elsevier Press, October 2009, 310 pages, see pp. 149-181. Alternatively, stain etching can be used to create the porous silicon layer in the bathtub region, in the absence of electric fields, using an etchant consisting of HF and a strong oxidizing agent, such as nitric acid.

In one embodiment, following the porous region created beneath the gold, the gold can be patterned and etched to create the optimal SERS patterns required for signal enhancement. Exemplar SERS patterns are discussed in Sharma et al., “SERS: Materials, Applications and the Future,” Materials Today, Vol. 15, Nos. 1-2, January-February 2012, pp. 16-25. This patterning step can be performed using nanoimprint lithography and a wet etch step as discussed below:
(1) after the creation of the porous area underneath the bathtub in the SZ portion of the wafer, the wafer is cleaned to remove all of the polymeric material using an oxygen plasma or a UV ozone clean;
(2) a thin (sub-10 nm) adhesion layer, such as the one reported in Choi et al., “UV Nanoimprint Lithography,” Handbook of Nanofabrication, edited by Gary Wiederrecht, Elsevier Press, October 2009, 310 pages, see pp. 149-181, is coated on the entire wafer;
(3) an imprint template that contains the desired SERS pattern is imprinted onto the adhesion layer at the bottom of the “bathtub.” The template has the desired SERS pattern on a “mesa” that fits into the bathtub. Once this imprint step is completed, there is a residual polymer layer of thickness 15-40 nm below the SERS patterns, while at the same time the rest of the wafer is covered with a residual polymer film of at least 75 nm or higher;
(4) next a residual layer (descum) etch similar to the one discussed in FIGS. 7 and 8A-8D is performed to etch the residual layer and the adhesion layer leading to expose the gold film in the recessed resist areas;
(5) next the wafer is subjected to a gold wet etchant to etch the gold SERS structures at the bottom of the bathtub; and
(6) Finally, the polymer imprint material is removed everywhere to complete the fabrication of the integrated SERS sensor on a porous silicon material in the SZ region. This allows the solvents and buffer liquids to be absorbed into the porous silicon, and the materials to be sensed (e.g., exosomes, biomolecules, proteins, etc.)

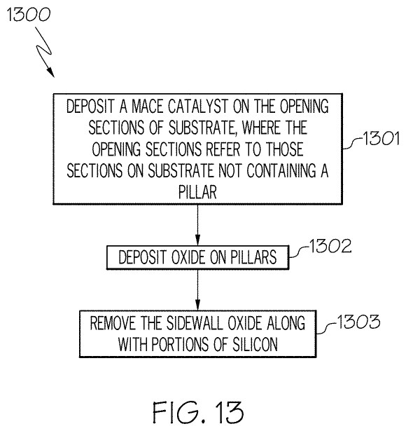

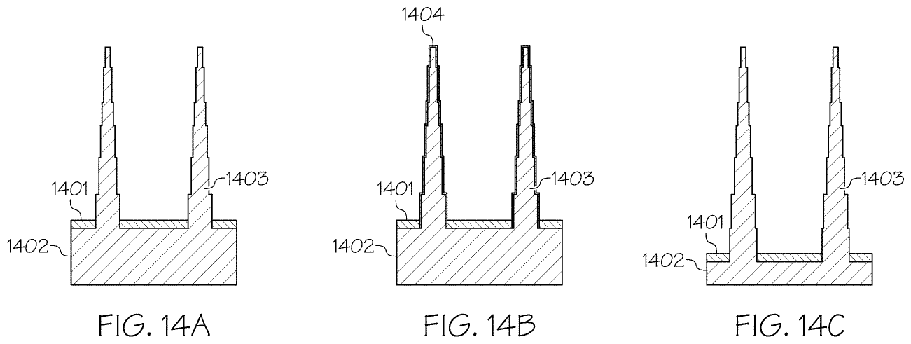

FIG. 13 is a flowchart of a method 1300 for creating self-aligned pillars using the MACE process in accordance with an embodiment of the present invention. FIGS. 14A-14C depict cross-sectional views for creating self-aligned pillars using the MACE process using the steps described in FIG. 13 in accordance with an embodiment of the present invention.

Referring to FIG. 13, in conjunction with FIGS. 14A-14C, in step 1301, a MACE catalyst 1401 is deposited on the opening sections of substrate 1402, where the opening sections refers to those sections on substrate 1402 not containing a pillar 1403 (e.g., tapered pillar) as shown in FIG. 14A. In one embodiment, such tapered pillars 1403 are created by the MACE process for DLD arrays 101. These pillars can be made with specific tapered geometries using the self-aligned multi-step MACE process as shown in FIG. 14A.

In step 1302, oxide 1404 is deposited and/or grown on pillars 1403, such as along their sidewalls, as shown in FIG. 14B. In one embodiment, the sidewall oxidation step is performed using common semiconductor oxidation techniques, such as thermal oxidation or exposure to oxygen plasma.

In step 1303, the sidewall oxide 1404 is removed (dissolved) along with portions of silicon 1402 as shown in FIG. 14C. For example, in one embodiment, the thin wall of oxide 1404 formed is removed using HF vapors or a short BOE dip.

As a result of using the principles of the present invention discussed above, biomarkers and trace amounts of nanoparticles in chemical mixtures or in water are effectively detected.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A diagnostic chip, comprising:
one or more inputs, wherein a sample containing differently sized particles is introduced into at least one of said one or more inputs; and
a plurality of separation regions, wherein said sample is pressurized as it passes through said plurality of separation regions, wherein each of said plurality of separation regions comprises a deterministic lateral displacement array, wherein said deterministic lateral displacement array in two or more of said plurality of separation regions has a different etch depth profile.

2. The diagnostic chip as recited in claim 1, wherein pillars in said deterministic lateral displacement array are fabricated using metal assisted chemical etching.

3. The diagnostic chip as recited in claim 1, wherein pillars in said deterministic lateral displacement array are fabricated using nanoimprint lithography.

4. The diagnostic chip as recited in claim 1, wherein said deterministic lateral displacement array is used for particle separation.

5. The diagnostic chip as recited in claim 1, wherein pillars in said deterministic lateral displacement array are tapered.

6. The diagnostic chip as recited in claim 1, wherein pillars in said deterministic lateral displacement array are created using metal assisted chemical etching and silicon oxidation.

7. The diagnostic chip as recited in claim 1, wherein pillars in said deterministic lateral displacement array have a diameter-to-pitch ratio of greater than 0.8, wherein said pillars are designed to prevent clogging of particles in said sample.

8. The diagnostic chip as recited in claim 1 further comprises:
a side-barrier array within said deterministic lateral displacement array for particle separation.

9. The diagnostic chip as recited in claim 1, wherein said sample comprises one of the following: blood, serum, saliva and urine.

10. A device for separation of one or more biological species, the device comprising:
a separation region comprising micro-scale or nano-scale structures, wherein an underlying substrate of said separation region is non-porous; and
at least one output region, wherein an underlying substrate of said at least one output region is porous.

11. The device as recited in claim 10 further comprises:
an integrated surface enhanced Raman spectroscopy (SERS) sensor with a porous silicon layer for detection of one or more biological species.

12. The device as recited in claim 11, wherein said porous silicon layer is designed to act as a drain for sample liquids while preventing particles in a fluid from seeping into pores in a porous region.

13. The device as recited in claim 10, wherein said device is a deterministic lateral displacement device fabricated using metal assisted chemical etching.

14. The device as recited in claim 10 further comprising:
a plurality of inputs, wherein a sample containing differently sized particles is introduced in one of said plurality of inputs, wherein said sample comprises one of the following: blood, serum, saliva and urine.
